(19) United States
(12) Patent Application Publication
(10) Pub. No.: US 2010/0112516 A1
(43) Pub. Date: May 6, 2010

(54) VIBRATIONAL FILLING DEVICE FOR IMPLANTING TOOTH BONE POWDER

(76) Inventor: Chun-Leon CHEN, Changhua City (TW)

Correspondence Address: Guice Patents PLLC, 12647 Galveston Court #302, Manassas, VA, 20112, US

(21) Appl. No.: 12/265,012

(22) Filed: Nov. 5, 2008

(51) Int. Cl. A61C 3/03

(52) U.S. Cl. 433/118

(57) ABSTRACT

A vibrational filling device for implanting tooth bone powder having a hand piece able to create vibration and adapted for holding by a hand, wherein an end of the hand piece is connected to a changeable bur, the bur takes advantage of the vibration created by the hand piece to propitiously fill bone powder into an area below a nasal sinus film able to be separated and lifted to increase the thickness of a cortical bone.

### BACKGROUND OF THE INVENTION

1. Field of the invention

The present invention relates to a vibrational filling device for implanting tooth bone powder, and especially to a filling device to fill bone powder in a vibrating mode into an area below a nasal sinus film able to be separated and lifted from a cortical bone.

2. Description of the Prior Art

In planting teeth in a oral cavity, for the purpose of increase the thickness (height) of the cortical bone 10 at the area to be implanted with the teeth in a sinus floor, the sinus floor shall be performed with a surgical operation of osteotomy, such as is shown in FIG. 1, an upper opening 11 shall be formed by drilling on a cortical bone 10. Then as shown in FIG. 2, a tool is used to separate and lift the sinus film 12 from the opening 11, and a pushing needle 22 of a bone powder filling tool 20 is used to fill bone powder 13 in a space below the separated and lifted sinus film 12 to increase the thickness (height) of the cortical bone 10 in favor of the process of the subsequent tooth implanting.

A conventional bone powder filling tool 20, as shown in FIG. 3, is a simple tool made of metal material, it has a handle 21 having on its one end a pushing needle 22; the pushing needle 22 is extended into the opening 11 after being attached with bone powder 13, the bone powder 13 is filled in the space below the separated and lifted sinus films 12.

Such a conventional manual tool is operated with a hand for filling in, it renders the action of filling bone powder 13 very hard and slow, hence time of operation is increased, not only a patient fills more uncomfortable, but also a doctor in charge of the operation feels the operation is a time and physical strength extremely consumptive work; particularly for a raw recruit, the work is more difficult, and improvement is wanted.

### SUMMARY OF THE INVENTION

The present invention provides a vibrational filling device for implanting tooth bone powder against the defect of the conventional bone powder filling hand tool, the filling device fills the bone powder into an little opening provided on a cortical bone with average pressure in a vibrating mode, for the purpose of reducing the time for surgical operation, reducing discomfort of patients and increasing the quality of operation processes of tooth planting, the patients and doctors can thereby both be favored.

The vibrational filling device for implanting tooth bone powder of the present invention mainly has a hand piece able to create vibration and adapted for holding by a hand, an end of the hand piece is connected to a changeable bur, the bur takes advantage of the vibration created by the hand piece to propitiously fill bone powder into an area below a nasal sinus film able to be separated and lifted from a cortical bone to increase the thickness of the cortical bone.

The hand piece of vibrational filling device for implanting tooth bone powder of the present invention can create vibration in an electric or air actuating mode.

The present invention will be apparent in its structure and its way of operation after reading the detailed description of the preferred embodiment thereof in reference to the accompanying drawings.

### BRIEF DESCRIPTION OF THE DRAWINGS

FIG. 1 is a schematic sectional view showing a sinus floor is performed with a surgical operation of osteotomy, and an opening is formed by drilling on a cortical bone;

FIG. 2 is a schematic sectional view showing a conventional bone powder filling tool is used to fill bone powder into an area below a separated and lifted nasal sinus film;

FIG. 3 is a perspective view showing the appearance of a conventional bone powder filling hand tool;

FIG. 4 is a perspective view showing the appearance of an embodiment of the present invention;

FIG. 5 is a sectional view showing operation of the embodiment of the present invention of FIG. 4.

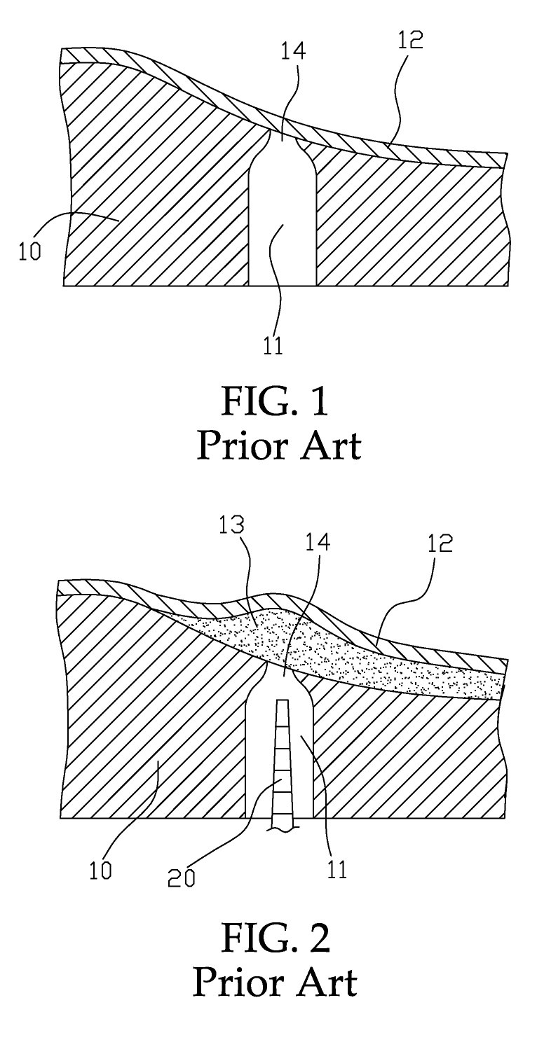

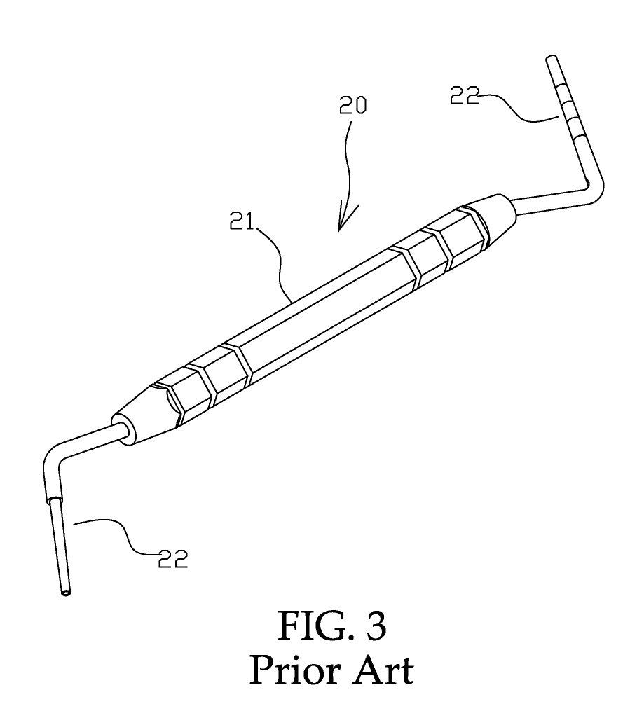

### DETAILED DESCRIPTION OF THE PREFERRED EMBODIMENT

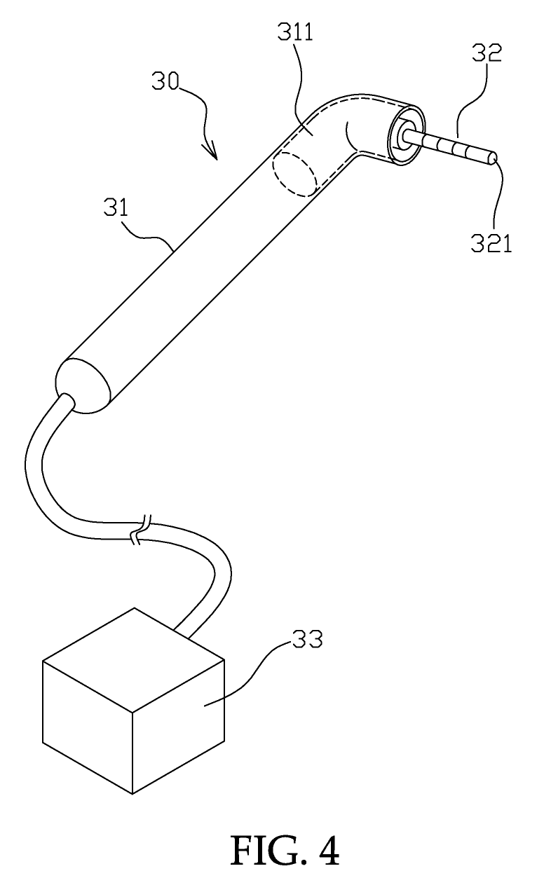

Referring to FIG. 4, a vibrational filling device 30 for implanting tooth bone powder of the present invention mainly has a hand piece 31 adapted for holding by a hand, and has a changeable bur 32.

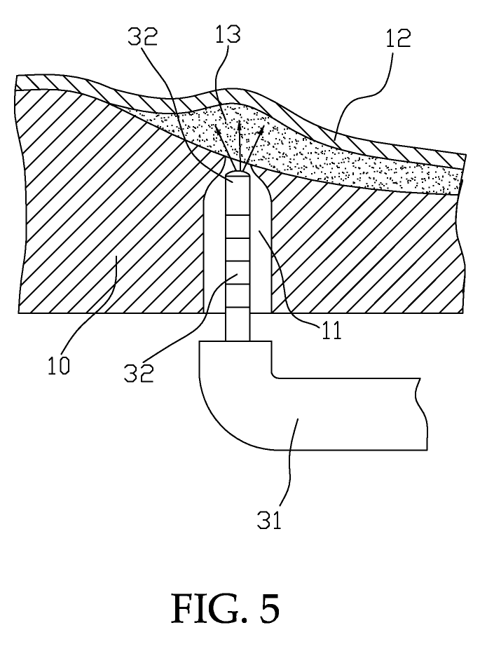

The hand piece 31 is provided therein with a vibration creating device 311 which can create vibration in an electric or air actuating mode. And a front end of the hand piece 31 is connected to the changeable bur 32 of which the surface is plated with titanium, the bur 32 has a size to be able to extend in an opening 11 as shown in FIG. 5, and is provided on its end with a cylindrical portion 321. The other end of the bur 32 being merged in the hand piece 31 is connected with the vibration creating device 311 that can create vibration to fill the bone powder 13 from the opening 11 into an area below a nasal sinus film 12 able to be separated and lifted from a cortical bone 10 with an average pressure to increase the thickness of the cortical bone 10.

And more, the hand piece 31 of the present invention can be connected to a main control unit 33 to control vibration generation of the vibration creating device 311 in an electric or air actuating mode.

The vibrational filling device 30 for implanting tooth bone powder of the present invention mainly is used to propitiously fill the bone powder 13 from the opening 11 on the cortical bone 10 into an area below a separated and lifted nasal sinus film 12 with an average pressure to overcome the difficulty of operation resided in a conventional hand tool. By virtue that the vibrational bur 32 fills the bone powder 13 into the cortical bone 10 fast and automatically, an effect of reducing the time for surgical operation, reducing discomfort of patients and increasing the quality of operation processes of tooth planting can be obtained, the patients and doctors can both be favored.

In conclusion, according to the description disclosed above, and having particularly described and ascertained the novelty and improvement of my invention and in what manner the same is to be performed, what we claim will be declared in the claims followed.

1. A vibrational filling device for implanting tooth bone powder, said bone powder is filled in a space below a sinus film adapted to being separated and lifted from a cortical bone to increase thickness of said cortical bone, said filling device comprises:
a hand piece adapted for holding by a hand, said hand piece is provided therein with a vibration creating device; and
a bur connected to a front end of said hand piece, and extended into an opening formed by drilling on a cortical bone; an end of said bur merged in said hand piece is connected with said vibration creating device that creates vibration to fill said bone powder from said opening into said space below said separated and lifted nasal sinus film with an average pressure to increase thickness of said cortical bone.

2. The vibrational filling device for implanting tooth bone powder as claimed in claim 1, wherein said vibration creating device provided in said hand piece creates vibration in an electric or air actuating mode.

3. The vibrational filling device for implanting tooth bone powder as claimed in claim 1, wherein said hand piece is connected to a main control unit to control vibration generation of said vibration creating device in an electric or air actuating mode.

4. The vibrational filling device for implanting tooth bone powder as claimed in claim 1, wherein said bur is adapted for changing, and is plated on its surface with titanium.

5. The vibrational filling device for implanting tooth bone powder as claimed in claim 1, wherein said bur is provided on its end with a cylindrical portion.
